(19) United States
(12) Patent Application Publication
(10) Pub. No.: US 2026/0241331 A1
(43) Pub. Date: Aug. 20, 2026

(54) MEMBRANE SEPARATION APPARATUS AND ENGINE EXHAUST APPARATUS

(71) Applicant: Hunan University, Changsha City (CN)

(72) Inventors: Yuanwang Deng, Changsha City (CN); Changling Feng, Changsha City (CN); Hao Zhu, Changsha City (CN)

(21) Appl. No.: 19/541,133

(22) Filed: Feb. 16, 2026

(30) Foreign Application Priority Data
Feb. 17, 2025 (CN) 202510167894.1

(51) Int. Cl. B01D 53/22; B01D 63/06; B01D 69/02; B01D 71/02

(52) U.S. Cl. CPC B01D 53/226; B01D 53/228; B01D 63/063; B01D 63/065; B01D 63/066; B01D 69/02; B01D 71/0211; B01D 71/027; B01D 2053/223; B01D 2257/504; B01D 2258/01; B01D 2325/36; B01D 2325/38

(57) ABSTRACT

Provided are a membrane separation apparatus and an engine exhaust apparatus. A primary separation membrane assembly includes a first cylindrical membrane and a first columnar membrane disposed in the first cylindrical membrane; a first space is formed between an inner diameter side of the first cylindrical membrane and an axial inner side of the first columnar membrane; the first space is an intake space; an axial outer side of the first columnar membrane forms a third space; an outer diameter side of the first cylindrical membrane forms a second space. A secondary separation membrane assembly includes a second cylindrical membrane and a second columnar membrane disposed in the second cylindrical membrane; the third space is formed between an axial inner side of the second cylindrical membrane and an axial inner side of the second columnar membrane; an outer diameter side of the second cylindrical membrane forms the second space.

### CROSS-REFERENCE TO RELATED APPLICATION

This patent application claims the benefit and priority of Chinese Patent Application No. 202510167894.1 filed with the China National Intellectual Property Administration on Feb. 17, 2025, the disclosure of which is incorporated by reference herein in its entirety as part of the present application.

### TECHNICAL FIELD

The present disclosure relates to the field of environmental protection technology, and in particular to a membrane separation apparatus and an engine exhaust apparatus.

### BACKGROUND

In the global transportation field, with the rapid economic development and continuous population growth, the number of vehicles has exceeded one billion. Although each vehicle generates relatively few carbon emissions during individual operation, the overall carbon emissions are extremely significant due to a large total number of vehicles, which has a serious impact on the global climate and environment. Therefore, how to effectively control and reduce carbon emissions in the transportation field has become an important issue that urgently needs to be addressed.

Regarding the capture of CO₂ emissions, various methods have been studied and applied, mainly including solvent absorption method, cryogenic separation method, membrane separation technology, and adsorption separation method.

The solvent absorption method utilizes the differences in solubility of different solutes in a solvent to separate and purify the target substance by selecting a suitable solvent. However, this method may face challenges in terms of solvent selection, recovery, treatment and the like in practical applications.

The cryogenic separation method, also called a deep cold separation method, is used to purify and recover CO₂ from a gas mixture by using low temperature liquefaction and separation distillation based on the difference in boiling points of different substances. However, this method requires high energy consumption and significant equipment costs, making it difficult to scale up for mass production and thus limiting its widespread application.

The membrane separation technology achieves separation based on different permeability of each component in a mixture through a membrane. With the continuous development of membrane synthesis technology, the membrane separation method has shown a wide application prospect in the aspect of CO₂ capture. Common CO₂ gas separation membrane materials include organic membranes such as polyoxyethylene and polyphenylene ether, as well as composite materials such as MOFs (Metal-Organic Frameworks), carbon membranes, and mixed matrix membranes. However, problems of the membrane materials such as performance, stability, and cost still need to be further studied and solved.

The adsorption separation method achieves separation and purification with action intensity differences between the adsorbent and the mixture under different operation conditions. Based on the different operation conditions, the adsorption separation method can be divided into Temperature Swing Adsorption (TSA) and Pressure Swing Adsorption (PSA). The Pressure Swing Adsorption is widely used in the gas adsorption and separation industry due to its advantages such as a low energy requirement, a simple operation process, and a short regeneration period of the adsorbent. For example, in a flue gas separation process, the Pressure Swing Adsorption separation process is mostly used for CO₂ capture.

However, at present, these CO₂ capture methods are mainly applied to large-scale energy equipment with high fossil fuel consumption and high concentrated CO₂ emission load in coal-fired power plants. For mobile and distributed energy equipment, such as transportation vehicles, no effective CO₂ capture technology has been applied in this field due to the complexity and diversity of the operating environments. Especially, in terms of engine carbon emission control, the focus is mainly on a combustion and utilization process of fossil fuels at present. However, the research and development of technologies in the CO₂ exhaust gas emission stage after combustion is still in a blank state.

### SUMMARY

An objective of the present disclosure is to provide a membrane separation apparatus and an engine exhaust apparatus, so as to solve the foregoing problems existing in the prior art. Four flow paths can be formed from an intake space to exhaust spaces, and the multiple flow paths are configured to circulate different gas components, and finally the target gas is separated.

In order to achieve the foregoing objective, the present disclosure provides the following solutions.

The present disclosure provides a membrane separation apparatus, including a primary separation membrane assembly and a secondary separation membrane assembly. The primary separation membrane assembly includes a first cylindrical membrane and a first columnar membrane, the first columnar membrane is disposed on an inner diameter side of the first cylindrical membrane and close to an end of the first cylindrical membrane; a first space is formed between the inner diameter side of the first cylindrical membrane and an axial inner side of the first columnar membrane; the first space is an intake space, an axial outer side of the first columnar membrane forms a third space, and an outer diameter side of the first cylindrical membrane forms a second space. The secondary separation membrane assembly includes a second cylindrical membrane and a second columnar membrane, the second columnar membrane is disposed on an inner diameter side of the second cylindrical membrane, the third space is formed between an axial inner side of the second cylindrical membrane and an axial inner side of the second columnar membrane; an outer diameter side of the second cylindrical membrane forms the second space, an axial outer side of the second cylindrical membrane forms a fourth space, an axial outer side of the second columnar membrane forms a fifth space; and the fourth space and the fifth space are exhaust spaces.

In an embodiment, a radial inner surface of the first cylindrical membrane is modified to be an H₂O-philic surface layer, and a radial outer surface of the first cylindrical membrane is modified to be an H₂O-phobic surface layer; an axial inner surface of the first columnar membrane is modified to be an H₂O-phobic surface layer, and an axial outer surface of the first columnar membrane is modified to be a CO₂-philic surface layer; an axial inner surface of the second cylindrical membrane is modified to be an H₂O-philic surface layer; and an axial inner surface of the second columnar membrane is modified to be a CO₂-philic surface layer, and a radial surface of the second columnar membrane is modified to be a CO₂-philic surface layer.

In an embodiment, the radial inner surface of the first cylindrical membrane comprises modified nanosilicon dioxide, and the radial outer surface of the first cylindrical membrane comprises modified graphite nanomaterials; the axial inner surface of the first columnar membrane comprises modified graphite nanomaterials, and the axial outer surface of the first columnar membrane comprises modified graphene nanomaterials; and the axial inner surface of the second cylindrical membrane comprises modified nanosilicon dioxide; and the axial inner surface of the second columnar membrane comprises modified graphene nanomaterials, and the radial surface of the second columnar membrane comprises modified graphene nanomaterials.

In an embodiment, an inner diameter of the first cylindrical membrane, an outer diameter of the first columnar membrane, and an outer diameter of the second cylindrical membrane are equal.

In an embodiment, an end face of the second cylindrical membrane is flush with an end face of the second columnar membrane, and an axial length of the second cylindrical membrane is equal to an axial length of the second columnar membrane.

In an embodiment, the membrane separation apparatus includes a main housing, and the main housing includes an outer housing and an inner housing that are mutually sleeved; an inner diameter side of the inner housing forms the third space; the second space is formed between an inner wall of the outer housing and an outer wall of the inner housing; the first space is disposed at an inlet end of the outer housing; and the fourth space and the fifth space are disposed at an outlet end of the outer housing.

In an embodiment, the membrane separation apparatus further includes an outlet pipeline. The outlet pipeline includes an inner pipe and an outer pipe that are mutually sleeved, an inner diameter side of the inner pipe forms the fifth space; and the fourth space is formed between an inner wall of the outer pipe and an outer wall of the inner pipe.

In an embodiment, the membrane separation apparatus further includes a first pressure sensor, a second pressure sensor, a third pressure sensor, a fourth pressure sensor, and a fifth pressure sensor, where the first pressure sensor is disposed in the first space, the second pressure sensor is disposed in the second space, the third pressure sensor is disposed in the third space, the fourth pressure sensor is disposed in the fourth space, and the fifth pressure sensor is disposed in the fifth space.

In an embodiment, the membrane separation apparatus further includes a first temperature sensor and a second temperature sensor, where the first temperature sensor is disposed in the first space, and the second temperature sensor is disposed in the fourth space and/or the fifth space.

The present disclosure provides an engine exhaust apparatus, including an exhaust pipe configured to be connected to an engine and the membrane separation apparatus as described above, where the first space is in communication with the exhaust pipe.

Compared with the prior art, the present disclosure achieves the following technical effects.

In the present disclosure, the primary separation membrane assembly and the secondary separation membrane assembly are utilized to partition the apparatus into the first space, the second space, the third space, the fourth space, and the fifth space. The four flow paths can be formed from the intake space to the exhaust space, that is, sequentially from the first space, the second space to the fourth space, sequentially from the first space, the second space to the fifth space, sequentially from the first space, the third space to the fourth space, and sequentially from the first space, the third space to the fifth space. The multiple flow paths may be used to circulate different gas components, and finally a target gas (such as CO₂) can be separated.

The present disclosure can be applied to CO₂ capture of mobile and distributed energy equipment such as traffic and transportation tools, which is of great significance for effectively controlling and reducing carbon emissions in the traffic and transportation field.

### BRIEF DESCRIPTION OF THE DRAWINGS

To more clearly illustrate embodiments of the present disclosure or technical solutions in the prior art, the following briefly introduces the accompanying drawings to be used in the embodiments. Apparently, the accompanying drawings in the following description show merely some embodiments of the present disclosure, and those skilled in the art can still derive other accompanying drawings from these drawings without creative efforts.

FIG. 1 is a schematic diagram of the overall structure of an engine exhaust apparatus according to an embodiment of the present disclosure;

FIG. 2 is a schematic diagram of a membrane separation apparatus according to an embodiment of the present disclosure;

FIG. 3 is a schematic diagram of a first cylindrical membrane according to an embodiment of the present disclosure;

FIG. 4 is a schematic diagram of a first columnar membrane according to an embodiment of the present disclosure;

FIG. 5 is a schematic diagram of a second cylindrical membrane according to an embodiment of the present disclosure;

FIG. 6 is a schematic diagram of a second columnar membrane according to an embodiment of the present disclosure; and

FIG. 7 is a principle diagram of a membrane separation apparatus according to an embodiment of the present disclosure.

Reference numerals in the drawings: 1—exhaust pipe; 2—first cylindrical membrane; 21—first hydrophobic layer; 22—first hydrophilic layer; 3—first columnar membrane; 31—second hydrophobic layer; 32—first carbon-dioxide-philic layer; 4—second cylindrical membrane; 41—second hydrophilic layer; 5—second columnar membrane; 51—second carbon-dioxide-philic layer; 52—third carbon-dioxide-philic layer; 6—fourth space; 7—fifth space; 8—third space; 9—second space; 10—first space; 11—first pressure sensor; 12—second pressure sensor; 13—third pressure sensor; 14—fourth pressure sensor; 15—fifth pressure sensor; 16—first temperature sensor; 17—second temperature sensor; 18—outer housing; 19—inner housing; 23—pollutant emission control system; 24—outer pipe; 25—inner pipe; 26—engine; 110—primary separation membrane assembly; and 120—secondary separation membrane assembly.

### DETAILED DESCRIPTION OF THE EMBODIMENTS

The following clearly and completely describes technical solutions in embodiments of the present disclosure with reference to drawings in the embodiments of the present disclosure. Apparently, the described embodiments are merely a part rather than all of the embodiments of the present disclosure. All other embodiments obtained by those skilled in the art on the basis of the embodiments of the present disclosure without creative efforts shall fall within the scope of protection of the present disclosure.

An objective of the present disclosure is to provide a membrane separation apparatus and an engine exhaust apparatus, so as to address the problems existing in the prior art. Four flow paths can be formed from an intake space to exhaust spaces, and the multiple flow paths are configured to circulate different gas components, and finally a to-be-separated gas is separated.

To make the foregoing objective, features and advantages of the present disclosure clearer and more comprehensible, the present disclosure is further described in detail below with reference to the drawings and the specific implementations.

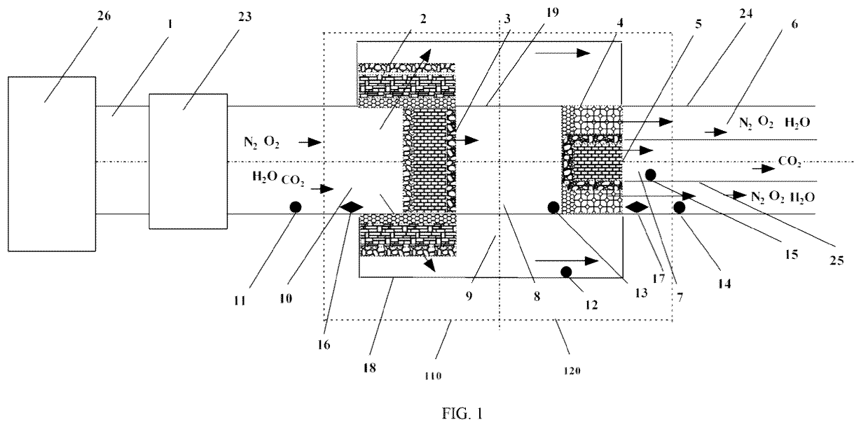

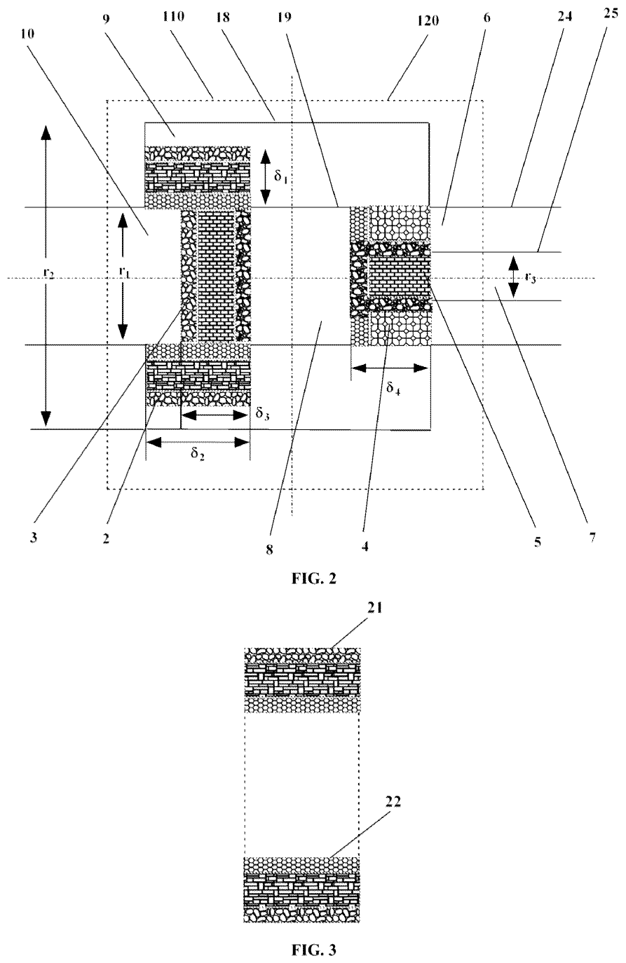

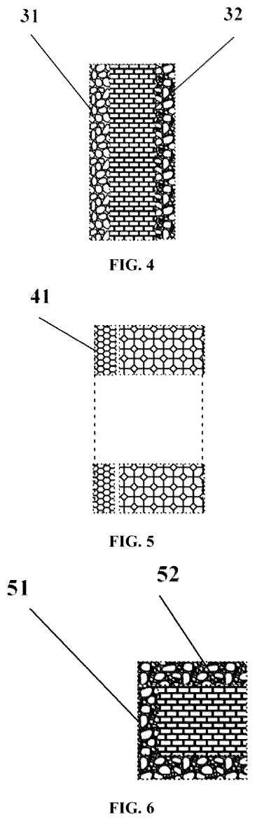

As shown in FIG. 1 to FIG. 7, the present disclosure provides a membrane separation apparatus, including a primary separation membrane assembly 110 and a secondary separation membrane assembly 120. The primary separation membrane assembly 110 includes a first cylindrical membrane 2 and a first columnar membrane 3. The first cylindrical membrane 2 may be a separation membrane of a cylindrical structure, and the first columnar membrane 3 may be a separation membrane of a columnar structure. The first columnar membrane 3 is disposed on an inner diameter side of the first cylindrical membrane 2 and close to an end of the first cylindrical membrane 2. Therefore, a first space 10 can be formed between the inner diameter side of the first cylindrical membrane 2 and an axial inner side of the first columnar membrane 3. The first space 10 is an intake space, and is used to be connected to a to-be-treated gas source of an exhaust pipe 1 of an engine 26. It should be noted that the axial inner side mentioned here and hereinafter refers to a side close to the intake space, and an axial outer side mentioned here and hereinafter refers to a side close to an exhaust space. An axial outer side of the first columnar membrane 3 is a third space 8, and an outer diameter side of the first cylindrical membrane 2 is a second space 9. The secondary separation membrane assembly 120 includes a second cylindrical membrane 4 and a second columnar membrane 5. The second cylindrical membrane 4 may be a separation membrane of a cylindrical structure, and the second columnar membrane 5 may be a separation membrane of a columnar structure. The second columnar membrane 5 is disposed on an inner diameter side of the second cylindrical membrane 4. The third space 8 is formed between an axial inner side of the second cylindrical membrane 4 and an axial inner side of the second columnar membrane 5. An outer diameter side of the second cylindrical membrane 4 forms the second space 9. An axial outer side of the second cylindrical membrane 4 forms a fourth space 6. An axial outer side of the second columnar membrane 5 forms a fifth space 7. The fourth space 6 and the fifth space 7 act as exhaust spaces.

In the present disclosure, the primary separation membrane assembly 110 and the secondary separation membrane assembly 120 are utilized to partition the apparatus into the first space 10, the second space 9, the third space 8, the fourth space 6, and the fifth space 7. The first space 10 is used as the intake space. The fourth space 6 and the fifth space 7 are used as the exhaust spaces. Four flow paths can be formed from the intake space to the exhaust space, that is, sequentially from the first space 10, the second space 9 to the fourth space 6, sequentially from the first space 10, the second space 9 to the fifth space 7, sequentially from the first space 10, the third space 8 to the fourth space 6, and sequentially from the first space 10, the third space 8 to the fifth space 7. Under the action of the primary separation membrane assembly 110 and the secondary separation membrane assembly 120, the multiple flow paths can be used to circulate different gas components, and finally a to-be-separated gas (such as CO₂) can be separated.

In an implementation, after the membrane separation apparatus in the present disclosure is installed in a pollutant emission control system 23 disposed in the exhaust pipe 1 of the engine 26, emissions in this case mainly include N₂, O₂, H₂O, and CO₂. Table 1 shows physical properties of CO₂ and the like, and Table 2 shows molecular diameters of CO₂ and the like. It can be seen from Table 1 and Table 2 that physicochemical properties of these emissions, properties such as molecular kinetic diameters of the emissions are obviously different. It is assumed that the molecular kinetic diameters are denoted by d_{N2}, d_{O2}, d_{H2O}, and d_{CO2}, respectively, where d_{H2O}<d_{CO2}<d_{N2}<d_{O2}. H₂O is a polar molecule, and N₂, O₂, and CO₂ are non-polar molecules. Because three bonds N≡N exist in the N₂ molecule, the N₂ molecule is the most stable in known diatomic molecules. The CO₂ molecule has low-energy unoccupied orbitals and relatively high electron affinity, and is more prone to accept electrons. Therefore, a separation membrane with a corresponding function can be designed, and CO₂ is separated from N₂, O₂, H₂O and CO₂ in the exhaust pipe 1 by using a separation technology of CO₂ emissions for engine 26 with a series two-stage separation membrane structure.

TABLE 1
Physical properties of CO₂ and the like

| | Relative | | Dipole | Quadrupole | | Polariza- |
|---|---|---|---|---|---|---|
| Gas | molecular | Kinetic | moment/×10¹⁸/ | moment/×10⁻⁴⁰/ | Boiling | tion/×10²⁵/ |
| type | mass/mol/g | diameter/Å | esu · m² | C · m² | point/K | cm³ |
| CO₂ | 44 | 3.3 | 0 | −14.9 | 194.7 | 29.1 |
| H₂O | 18 | 2.641 | 1.8546 | — | 373.15 | 14.5 |
| O₂ | 32 | 3.467 | 0 | −1.33 | 90.17 | 15.812 |
| N₂ | 28 | 3.64-3.80 | 0 | −4.9 | 77.35 | 17.403 |

TABLE 2
Diameters/Å of CO₂ and other molecules

| | He | H₂ | CO₂ | O₂ | N₂ | CH₄ | C₂H₄ | C₃H₆ |
|---|---|---|---|---|---|---|---|---|
| Kinetic | 2.60 | 2.89 | 3.30 | 3.46 | 3.64 | 3.80 | 3.9 | 4.5 |
| diameter | | | | | | | | |
| Collision | 2.58 | 2.92 | 4.00 | 3.43 | 2.68 | 3.82 | 4.42 | 5.06 |
| diameter | | | | | | | | |
| Effective | 2.59 | 2.90 | 3.63 | 3.44 | 3.66 | 3.81 | / | / |
| diameter | | | | | | | | |

In an embodiment, the radial inner surface of the first cylindrical membrane 2 is modified to be an H₂O-philic surface layer, that is, a first hydrophilic layer 22, and a radial outer surface of the first cylindrical membrane 2 is modified to be an H₂O-phobic surface layer, that is, a first hydrophobic layer 21. An axial inner surface of the first columnar membrane 3 is modified to be an H₂O-phobic surface layer, that is, a second hydrophobic layer 31, and an axial outer surface of the first columnar membrane 3 is modified to be a CO₂-philic surface layer, that is, a first carbon-dioxide-philic layer 32. An axial inner surface of the second cylindrical membrane 4 is modified to be an H₂O-philic surface layer, that is, a second hydrophilic layer 41. An axial inner surface of the second columnar membrane 5 is modified to be a CO₂-philic surface layer, that is, a second carbon-dioxide-philic layer 51, and a radial surface of the second columnar membrane 5 is modified to be a CO₂-philic surface layer, that is, a third carbon-dioxide-philic layer 52.

In an embodiment, the radial inner surface of the first cylindrical membrane 2 employs modified nanosilicon dioxide, and the radial outer surface of the first cylindrical membrane 2 employs a modified graphite nanomaterial. The axial inner surface of the first columnar membrane 3 employs a modified graphite nanomaterial, and the axial outer surface of the first columnar membrane 3 employs a modified graphene nanomaterial. The axial inner surface of the second cylindrical membrane 4 employs modified nanosilicon dioxide. The axial inner surface of the second columnar membrane 5 employs a modified graphene nanomaterial, and the radial surface of the second columnar membrane 5 employs a modified graphene nanomaterial.

In an embodiment, the primary separation membrane assembly 110 and the secondary separation membrane assembly 120 have the following features:

A primary separation membrane assembly 110: A first cylindrical membrane 2, where the used membrane is a microporous membrane that follows a molecular sieving mechanism. Functions of the first cylindrical membrane 2 are mainly to separate CO₂ from N₂, O₂, and H₂O, and select a molecular sieve membrane made of a molecular sieve material ZSM-5 (5.2-5.5 Å) based on a size of d_{O2}, with a pore size denoted by da. The radial inner surface is modified to be the H₂O-philic surface layer with the nanosilicon dioxide, and the radial outer surface is modified to be the H₂O-phobic surface layer with the graphite nanomaterial. A modification process of membrane surfaces is completed with an impregnation method, where d_{H2O}<d_{CO2}<d_{N2}<d_{O2}<da. A first columnar membrane 3, where the used membrane is a microporous membrane that follows a molecular sieving mechanism, and simultaneously has a partial action of an absorption membrane. Functions of the first cylindrical membrane 3 are mainly to separate CO₂ from H₂O, but block N₂ and O₂ by the membrane, and select a molecular sieve membrane (4 Å) made of an A-type molecular sieve (referred to as Na-A type commercially) material after Na⁺ exchange from LTA type zeolite based on a size of d_{CO2}, with a pore size denoted by d_{b}. The radial inner surface is modified to be the H₂O-phobic surface layer with the graphite nanomaterial, and the radial outer surface is modified to be the CO2-philic surface layer with the graphene nanomaterial. A modification process of membrane surfaces is completed with an impregnation method, where on the membrane surfaces, d_{H2O}<d_{CO2}<d_{b}<d_{N2}<d_{O2}.

A secondary separation membrane assembly 120: A second cylindrical membrane 4, where the used membrane is a microporous membrane that follows a molecular sieving mechanism. Functions of the second cylindrical membrane 4 are mainly to separate CO₂ from H₂O, separate N₂, O₂, and H₂O in a radial direction, and select a molecular sieve membrane made of a molecular sieve material ZSM-5 (5.2-5.5 Å), with a pore size denoted by d_{c}, where d_{H2O}<d_{CO2}<d_{N2}<d_{O2}<d_{c}. The axial inner surface is modified to be the H₂O-philic surface layer with the nanosilicon dioxide, and a modification process of a membrane surface is completed with an impregnation method. On the H₂O-philic surface layer, it should be that: d_{H2O}<d_{CO2}<d_{c}<d_{N2}<d_{O2}. A second columnar membrane 5, where the used membrane is a microporous membrane that follows a molecular sieving mechanism, and simultaneously has a partial action of an absorption membrane. Functions of the second columnar membrane 5 are mainly to separate CO₂ from H₂O, and select a molecular sieve membrane (4 Å) made of an A-type molecular sieve (referred to as Na-A type commercially) material after Na⁺ exchange from LTA type zeolite is selected based on a size of d_{CO2}, with a pore size denoted by d_{d}. The radial inner surface is modified to be the CO₂-philic surface layer with the graphene nanomaterial, and the radial outer surface is modified to be the CO₂-philic surface layer with the graphene nanomaterial. A modification process of membrane surfaces is completed with an impregnation method, where on the membrane surfaces, d_{H2O}<d_{CO2}<d_{d}<d_{N2}<d_{O2}.

In an embodiment, an inner diameter of the first cylindrical membrane 2, an outer diameter of the first columnar membrane 3, and an outer diameter of the second cylindrical membrane 4 are equal. The first columnar membrane 3 is embedded into the first cylindrical membrane 2 from one end, and is flush with an end face of the exhaust space. It is convenient that the first columnar membrane 3 and the second columnar membrane 5 are connected to the exhaust pipe 1, and the first space 10 can be formed.

In an embodiment, end faces of the second cylindrical membrane 4 and the second columnar membrane 5 are flush, and an axial length of the second cylindrical membrane 4 is equal to that of the second columnar membrane 5. It is convenient to divide the fourth space 6 and the fifth space 7 on the axial outer side.

For dimensions of the first cylindrical membrane 2, an inner diameter is r₁, a radial wall thickness is δ₁, and an axial height is δ₂. For dimensions of the first columnar membrane 3, a diameter is r₁, and an axial height is δ₃. For dimensions of the second cylindrical membrane 4, an outer diameter is r₁, an inner diameter is r₃, and an axial height is δ₄. For dimensions of the second columnar membrane 5, an axial height is δ₄, and a diameter is r₃. The dimensions can be designed and adjusted based on actual requirements.

In an embodiment, the membrane separation apparatus includes a main housing, where the main housing includes an outer housing 18 and an inner housing 19 that are mutually sleeved. A diameter of the outer housing 18 is denoted by r₂, and a diameter of the inner housing 19 is approximately equal to r₁. An inner diameter side of the inner housing 19 forms the third space 8. The third space 8 is a columnar space. The second space 9 is formed between an inner wall of the outer housing 18 and an outer wall of the inner housing 19. The second space 9 is an annular space. The first space 10 is disposed at an inlet end of the outer housing 18. The first space 10 is a columnar space. The fourth space 6 and the fifth space 7 are disposed at an outlet end of the outer housing 18. The fourth space 6 is an annular space, and the fifth space 7 is a columnar space.

In an embodiment, The membrane separation apparatus further includes an outlet pipeline, where the outlet pipeline includes an inner pipe 25 and an outer pipe 24 that are mutually sleeved, an inner diameter side of the inner pipe 25 forms the fifth space 7, and the fourth space 6 is formed between an inner wall of the outer pipe 24 and an outer wall of the inner pipe 25.

In an embodiment, the membrane separation apparatus further includes a first pressure sensor 11, a second pressure sensor 12, a third pressure sensor 13, a fourth pressure sensor 14, and a fifth pressure sensor 15, where the first pressure sensor 11 is disposed in the first space 10, the second pressure sensor 12 is disposed in the second space 9, the third pressure sensor 13 is disposed in the third space 8, the fourth pressure sensor 14 is disposed in the fourth space 6, and the fifth pressure sensor 15 is disposed in the fifth space 7. Each pressure sensor is disposed in each space, so as to monitor pressure status of each space. P₁, P₂, P₃, P₄, and P₅ are respectively used to represent a pressure value of each space, and are fed back to an ECU (electronic control unit, that is, a computer control module) of the engine 26, so as to monitor pressure status on both sides of the membrane during operation, so as to ensure that the primary separation membrane assembly 110 and the secondary separation membrane assembly 120 run under a proper pressure environment. Because the membrane separates N₂, O₂, H₂O and CO₂ successfully, the result is: P₁>P₂>P₃>P₄>P₅.

In an embodiment, the membrane separation apparatus further includes a first temperature sensor 16 and a second temperature sensor 17, where the first temperature sensor 16 is disposed in the first space 10, and the second temperature sensor 17 is disposed in the fourth space 6 and/or the fifth space 7. The membrane operates within a certain temperature range, a structure of the membrane material may be damaged because of an excessive temperature. The first temperature sensor 16 and the second temperature sensor 17 are respectively disposed at an inlet and an outlet of the membrane separation apparatus, so as to respectively monitor temperature T₁ of the inlet of the primary membrane separation assembly 110 and temperature T₂ of the outlet of the secondary membrane separation assembly 120. The temperatures T₁ and T₂ are fed back to the ECU of the engine 26, so as to monitor a temperature condition of the membrane during operation process, thereby ensuring that the primary membrane separation assembly 110 and the secondary membrane separation assembly 120 operate under a proper temperature environment.

A working principle of the membrane separation apparatus in the present disclosure is as follows:

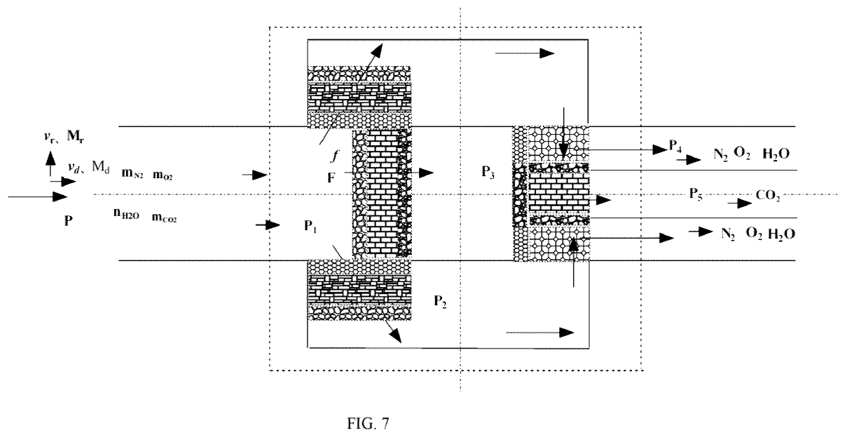

As shown in FIG. 7, molecular weights of N₂, O₂, H₂O, and CO₂ are denoted by m_{N2}, m_{O2}, m_{H2O}, and m_{CO2}. After the pollutant emission control system 23 of the engine 26, axial velocity and radial velocity components are denoted by v_{d} and vᵣ, respectively; pressures are denoted by P; axial momentum and radial momentum components are denoted by M_{d} and Mᵣ, respectively; and acting forces and resistance forces to the membrane surface are denoted by F and f, respectively. Thus, (1) v_{d}>vᵣ; (2) From the definition of momentum M=(½)mv², M_{d}>Mᵣ.

A working process of the primary separation membrane assembly 110 is as follows:
(1) Because v_{d}>vᵣ, CO₂, N₂, O₂, and H₂O first mainly interact with the first columnar membrane 3. Given d_{H2O}<d_{CO2}<d_{b}<d_{N2}<d_{O2}, N₂ and O₂ are blocked by the membrane, so CO₂ and H₂O mainly interact with the first columnar membrane 3. Due to the hydrophobicity of the axial inner surface, for the force F_{H2O} of water on the surface and the acting force (resistance force) f_{H2O} of the surface on water, there is: F_{H2O}<f_{H2O}. Therefore, although d_{H2O}<d_{b}, for the regions (first space 10 and third space 8) on both sides of the membrane there is P₁>P₃, but all or most of H₂O cannot pass through the membrane. It is assumed that an axial momentum of H₂O molecules is M_{dH2O}. Because v_{d} is relatively large and M_{dH2O} is also relatively large, F_{H2O}>f_{H2O}. Therefore, some H₂O molecules enter the third space 8 from the first space 10 through the separation membrane. However, the CO₂ molecule does not act as f_{CO2} on the membrane surface, and since d_{CO2}<d_{b}, P₁>P₃, M_{dCO2} is relatively large. The axial outer surface is a CO₂-philic surface layer, and the graphene nanomaterial is prone to heating up. Therefore, CO₂ is mainly separated from the first columnar membrane 3 and enters the third space 8 from the first space 10.
(2) Due to an impact of the first columnar membrane 3, near the surface of the first columnar membrane 3, for N₂, O₂, and some CO₂ and H₂O, there is v_{d}<vᵣ. For the first cylindrical membrane 2, regarding the first space 10 and the second space 9 on both sides of the membrane, there is P₁>P₂. The relationship between the molecular kinetic diameter and a membrane hole diameter is: d_{H2O}<d_{CO2}<d_{N2}<d_{O2}<da, so that all N₂ and O₂, and some H₂O and CO₂ enter the second space 9 from the first space 10 through the separation membrane. As for the H₂O molecule, due to the hydrophilicity of the radial inner surface and the hydrophobicity of the radial outer surface of the first cylindrical membrane 2, so that the H₂O molecule is subjected to the absorption force f_{H2O} on the radial inner surface of the first cylindrical membrane 2, and is more prone to enter membrane pores, while the H₂O molecule is subjected to a repulsive force f_{H2O} on the radial outer surface of the first cylindrical membrane 2, and is more prone to separate out from the surface of the membrane.

A working process of the secondary separation membrane assembly 120 is as follows:
(1) In the third space 8, there is CO₂ mainly, and a small quantity of H₂O is further included. CO₂ mainly interacts with the second columnar membrane 5. For the third space 8 and the fifth space 7 on both sides of the second columnar membrane 5, P₃>P₅. Because of the CO₂-philic surface layer of the second columnar membrane 5, CO₂ is subjected to absorption force f_{CO2}, and is more prone to enter the membrane pores, and the graphene nanomaterial is also prone to heating up, so that CO₂ enters the fifth space 7 from the third space 8 to complete CO₂ separation. A small amount of H₂O, due to the hydrophilicity of the axial inner surface of the second cylindrical membrane 4, causes the H₂O molecules to be subjected to the absorption force f_{H2O} on the radial inner surface of the second cylindrical membrane 4, and are more prone to enter the membrane pores. For the third space 8 and the fourth space 6 on both sides of the second cylindrical membrane 4, there is P₃>P₄, so H₂O is separated from the third space 8 to enter the fourth space 6.
(2) In the second space 9, there is N₂, O₂, and H₂O mainly, and a small amount of CO₂ is further included. For the second cylindrical membrane 4, there is d_{H2O}<d_{CO2}<d_{N2}<d_{O2}<dc, and P₂>P₄. Therefore, N₂, O₂, and H₂O can be separated from the second space 9 to enter the fourth space. As for CO₂, due to the CO₂-philic surface layer of the second columnar membrane 5, CO₂ is subjected to the absorption force f_{CO2}, and is more prone to enter the membrane pores. In addition, the graphene nanomaterial is also prone to heating up, so that CO₂ enters the fifth space 7 from the second space 9 to complete CO₂ separation.

In summary, after the working processes of the primary separation membrane assembly 110 and the secondary separation membrane assembly 120 are performed, N₂ and O₂ are separated out through the first space 10, the second space 9, and the fourth space 6. H₂O is separated out mainly through the first space 10, the second space 9, and the fourth space 6, and a small part of H₂O is separated out through the first space 10, the third space 8, and the fourth space 6. In addition, CO₂ is separated out mainly through the first space 10, the third space 8, and the fifth space 7, and a small part of CO₂ is separated out through the first space 10, the second space 9, and the fifth space 7.

As shown in FIG. 1 to FIG. 7 again, the present disclosure provides an engine exhaust apparatus, including an exhaust pipe 1 used to be connected to an engine 26 and a membrane separation apparatus recorded in the foregoing. The membrane separation apparatus uses two stages of separation membrane structures in series (a primary separation membrane assembly 110 and a secondary separation membrane assembly 120). The first space 10 is in communication with the exhaust pipe 1. In addition, a pollutant emission control system 23, such as a three-way catalytic converter, may be disposed between the first space 10 and the exhaust pipe 1. The apparatus includes the exhaust pipe 1, the primary separation membrane assembly 110, and the secondary separation membrane assembly 120, and is divided into five areas with different pressures, such as the first space 10, the second space 9, the third space 8, the fourth space 6, and the fifth space 7, that become separation paths of N₂, O₂, H₂O, and CO₂. After separation of the primary separation membrane assembly 110 and the secondary separation membrane assembly 120, emitted CO₂ gas may be collected in the fifth space 7.

In the present disclosure, specific examples are used for illustration of the principles and implementations of the present disclosure. The description of the above-mentioned embodiments is used to help illustrate the method and core principles of the present disclosure. In addition, those skilled in the art can make various modifications in terms of specific implementations and scope of application in accordance with the teachings of the present disclosure. In summary, the contents of this specification should not be understood as the limitation of the present disclosure.

What is claimed is:

1. A membrane separation apparatus, comprising:
a primary separation membrane assembly, wherein the primary separation membrane assembly comprises a first cylindrical membrane and a first columnar membrane, the first columnar membrane is disposed on an inner diameter side of the first cylindrical membrane and close to an end of the first cylindrical membrane; a first space is formed between the inner diameter side of the first cylindrical membrane and an axial inner side of the first columnar membrane; the first space is an intake space, an axial outer side of the first columnar membrane forms a third space, and an outer diameter side of the first cylindrical membrane forms a second space;
and a secondary separation membrane assembly, wherein the secondary separation membrane assembly comprises a second cylindrical membrane and a second columnar membrane, the second columnar membrane is disposed on an inner diameter side of the second cylindrical membrane, the third space is formed between an axial inner side of the second cylindrical membrane and an axial inner side of the second columnar membrane; an outer diameter side of the second cylindrical membrane forms the second space, an axial outer side of the second cylindrical membrane forms a fourth space, an axial outer side of the second columnar membrane forms a fifth space; and the fourth space and the fifth space are exhaust spaces;
wherein a radial inner surface of the first cylindrical membrane is modified to be an H₂O-philic surface layer, and a radial outer surface of the first cylindrical membrane is modified to be an H₂O-phobic surface layer; an axial inner surface of the first columnar membrane is modified to be an H₂O-phobic surface layer, and an axial outer surface of the first columnar membrane is modified to be a CO₂-philic surface layer; an axial inner surface of the second cylindrical membrane is modified to be an H₂O-philic surface layer; and an axial inner surface of the second columnar membrane is modified to be a CO₂-philic surface layer, and a radial surface of the second columnar membrane is modified to be a CO₂-philic surface layer;
wherein the radial inner surface of the first cylindrical membrane comprises modified nanosilicon dioxide, and the radial outer surface of the first cylindrical membrane comprises modified graphite nanomaterials; the axial inner surface of the first columnar membrane comprises modified graphite nanomaterials, and the axial outer surface of the first columnar membrane comprises modified graphene nanomaterials; and the axial inner surface of the second cylindrical membrane comprises modified nanosilicon dioxide; and the axial inner surface of the second columnar membrane comprises modified graphene nanomaterials, and the radial surface of the second columnar membrane comprises modified graphene nanomaterials.

2. The membrane separation apparatus according to claim 1, wherein an inner diameter of the first cylindrical membrane, an outer diameter of the first columnar membrane, and an outer diameter of the second cylindrical membrane are equal.

3. The membrane separation apparatus according to claim 1, wherein an end face of the second cylindrical membrane is flush with an end face of the second columnar membrane, and an axial length of the second cylindrical membrane is equal to an axial length of the second columnar membrane.

4. The membrane separation apparatus according to claim 1, comprising a main housing, wherein the main housing comprises an outer housing and an inner housing that are mutually sleeved; an inner diameter side of the inner housing forms the third space; the second space is formed between an inner wall of the outer housing and an outer wall of the inner housing; the first space is disposed at an inlet end of the outer housing; and the fourth space and the fifth space are disposed at an outlet end of the outer housing.

5. The membrane separation apparatus according to claim 3, further comprising an outlet pipeline, wherein the outlet pipeline comprises an inner pipe and an outer pipe that are mutually sleeved, an inner diameter side of the inner pipe forms the fifth space; and the fourth space is formed between an inner wall of the outer pipe and an outer wall of the inner pipe.

6. The membrane separation apparatus according to claim 1, further comprising a first pressure sensor, a second pressure sensor, a third pressure sensor, a fourth pressure sensor, and a fifth pressure sensor, wherein the first pressure sensor is disposed in the first space, the second pressure sensor is disposed in the second space, the third pressure sensor is disposed in the third space, the fourth pressure sensor is disposed in the fourth space, and the fifth pressure sensor is disposed in the fifth space.

7. The membrane separation apparatus according to claim 1, further comprising a first temperature sensor and a second temperature sensor, wherein the first temperature sensor is disposed in the first space, and the second temperature sensor is disposed in the fourth space and/or the fifth space.

8. An engine exhaust apparatus, comprising an exhaust pipe configured to be connected to an engine and the membrane separation apparatus according to claim 1, wherein the first space is in communication with the exhaust pipe.

9. The engine exhaust apparatus, comprising an exhaust pipe configured to be connected to an engine and the membrane separation apparatus according to claim 1, wherein an inner diameter of the first cylindrical membrane, an outer diameter of the first columnar membrane, and an outer diameter of the second cylindrical membrane are equal.

10. The engine exhaust apparatus, comprising an exhaust pipe configured to be connected to an engine and the membrane separation apparatus according to claim 1, wherein an end face of the second cylindrical membrane is flush with an end face of the second columnar membrane, and an axial length of the second cylindrical membrane is equal to an axial length of the second columnar membrane.

11. The engine exhaust apparatus, comprising an exhaust pipe configured to be connected to an engine and the membrane separation apparatus according to claim 1, wherein the membrane separation apparatus comprises a main housing, and the main housing comprises an outer housing and an inner housing that are mutually sleeved; an inner diameter side of the inner housing forms the third space; the second space is formed between an inner wall of the outer housing and an outer wall of the inner housing; the first space is disposed at an inlet end of the outer housing; and the fourth space and the fifth space are disposed at an outlet end of the outer housing.

12. The engine exhaust apparatus, comprising an exhaust pipe configured to be connected to an engine and the membrane separation apparatus according to claim 1, wherein the membrane separation apparatus comprises an outlet pipeline, and the outlet pipeline comprises an inner pipe and an outer pipe that are mutually sleeved, an inner diameter side of the inner pipe forms the fifth space; and the fourth space is formed between an inner wall of the outer pipe and an outer wall of the inner pipe.

13. The engine exhaust apparatus, comprising an exhaust pipe configured to be connected to an engine and the membrane separation apparatus according to claim 1, wherein the membrane separation apparatus comprises a first pressure sensor, a second pressure sensor, a third pressure sensor, a fourth pressure sensor, and a fifth pressure sensor, wherein the first pressure sensor is disposed in the first space, the second pressure sensor is disposed in the second space, the third pressure sensor is disposed in the third space, the fourth pressure sensor is disposed in the fourth space, and the fifth pressure sensor is disposed in the fifth space.

14. The engine exhaust apparatus, comprising an exhaust pipe configured to be connected to an engine and the membrane separation apparatus according to claim 1, wherein the membrane separation apparatus comprises a first temperature sensor and a second temperature sensor, wherein the first temperature sensor is disposed in the first space, and the second temperature sensor is disposed in the fourth space and/or the fifth space.
